(19) United States
(12) Patent Application Publication
(10) Pub. No.: US 2006/0235550 A1
(43) Pub. Date: Oct. 19, 2006

(54) Creation of playlists using audio identification

(76) Inventors: Tibor George Csicsatka, San Marcos, CA (US); Matt Liam Date, San Diego, CA (US); Martin George Peters, Fishers (FR)

Correspondence Address: THOMSON LICENSING INC., PATENT OPERATIONS, PO BOX 5312, PRINCETON, NJ, 08543-5312, US

(21) Appl. No.: 10/553,811

(22) PCT Filed: Apr. 23, 2004
(86) PCT No.: PCT/US04/12459

§ 371 Date: Oct. 18, 2005

Related U.S. Application Data
(60) Provisional application No. 60/465,156, filed on Apr. 24, 2003.

(51) Int. Cl. G06F 17/00

(52) U.S. Cl. 700/94

(57) ABSTRACT

A method for creating a playlist uses audio clips (i.e. a segment or portion of predetermined or selectable audio content from an audio data file) for audio data file recognition. Attributes of an audio clip may be selectable by the user such as length of playing time, audio file portion, an audio file category, data in an ID3 tag or the like. A user interface allows the user to add identifying data representative of an audio data file associated with an audio clip to the playlist. The method is applicable to all types of devices that play back audio content from a multitude of stored audio content. In particular, the method includes playback of an audio clip from each one of a set of audio data files during the playing of the audio clip. During playback of a particular audio clip, the user may add the selection to the playlist. Particularly, identifying data representative of an audio file associated with the currently playing audio clip is added to the playlist in response to user input. A user interface allows, for example, a single button or control to add content to a default, currently selected, or selectable playlist.

This application claims the benefit under 35 U.S.C. § 365 of the International Application, PCT/US2004/012459, filed Apr. 23, 2004, which was published in accordance with PCT Article 21(2) on Nov. 11, 2004 in English and which claims the benefit of U.S. provisional patent application No. 60/465,156, filed Apr. 24, 2003.

### BACKGROUND

1. Field of the Invention

The present invention relates to creation of playlists on a storage device for digital content and, more particularly, to the creation of playlists on a storage device for digital audio content using audio identification.

2. Background Information

Music and other types of audio and/or audio programming is available as digital audio data that can then be used by devices capable of reading and/or playing digital audio data. The digital audio data is also typically stored in the device. While the personal computer (PC) is one type of device that stores and plays digital audio data, lately, the use of portable audio data players capable of playing digitally encoded audio data has become commonplace.

In particular, relatively small handheld devices that can process digitally encoded audio data stored on solid state memory devices have become popular. Additionally, as demand has increased for higher data storage capacity in portable audio data players, another generation of players has been developed and is gaining popularity. These portable audio data players include miniaturized high capacity storage devices, for example hard drives.

In the typical audio data player, the digital audio data is loaded into a data storage device by first downloading the data to a PC from an audio CD, the Internet, or another source of digital audio data. The data may be in compressed form according to a selected encoding format, or subsequently compressed, and loaded into the data storage device associated with the audio data player. The audio data is decompressed and/or decoded by the audio data player during playback according to the selected encoding format. A variety of encoding formats for compressing and decompressing audio data is available. One such encoding format is MP3.

Audio data file management programs that allow the user to manipulate the audio data files, such as to create and edit what are known are playlists (i.e. lists of identifying data associated with selected audio data files). The playlists can then be used by the PC and/or downloaded to a portable audio data player and used for playing a particular sequence of audio data files in accordance with the identifying data stored therein. Portable audio data players now have various features and/or functions that allow the user to manipulate the audio data files through its own audio data file management programs, features and/or functions, including playlists.

However, no matter whether a PC-based audio data file management program or a portable audio data player program is utilized to create a playlist, the current manner of creating playlists is a difficult and time-consuming process. Often, people do not even bother to create playlists because of the effort required.

One problem is that devices that allow users to create playlists are based on visual identification of audio content, for example, through a display of the song title. Once the user recognizes the audio content through visual indicia, the user may then add the audio content to the playlist. This manner of creating playlists proves to be difficult and not be intuitive to the user since it requires the user to rely solely on his or her memory to recognize the selection or associate the content to the title or other visual indicia. Often visual indicia, such as the song title, may not be familiar to the user, or be easily associated with the actual song. In the event that the user does not recognize a musical selection by the visual indicia, he or she must select the song in question to be played, listen for a period of time, and then stop the playing of the selection when it has recognized and either selected for the playlist or actively not selected for inclusion on the playlist. This may be particularly problematic where the device may potentially include thousands of songs.

It is quite evident from the above that the current process for creating playlists is rather time consuming and/or cumbersome in view of the number of steps required for playlist creation.

It is thus evident from the above discussion that what is needed is an easier and/or more user intuitive manner of creating playlists.

It is thus further evident from the above discussion that what is needed is a device that allows playlist creation based on audio identification, audio indicia and/or audio content.

It is still further evident from the above discussion that what is needed is a device that incorporates the above needs.

These needs and others are accomplished through application of the principles of the subject invention and/or as embodied in one or more various forms and/or structures such as are shown and/or described herein.

### SUMMARY OF THE INVENTION

A method, applicable to all types of devices that play back audio content from a multitude of stored audio content, for creating a playlist uses audio clips (i.e. a segment or portion of predetermined or selectable audio content from an audio data file) for audio data file recognition. A user interface allows the user to add identifying data representative of an audio data file associated with an audio clip to the playlist during playing of the audio clip. In this manner, recognition of an audio data file is accomplished through audio indicia associated with the audio file, which is easier and more intuitive for the user.

In particular, the method includes playing back an audio clip from each one of a set of audio data files in response to user input. During playback of a particular audio clip, the user may add the selection corresponding to the audio clip being played to the playlist by pressing the appropriate key or input device on the player. Particularly, identifying data representative of an audio file associated with the currently playing audio clip is added to the playlist in response to user input.

Attributes of audio clips may be selectable by the user. Default settings may be used or the user may select to customize one or more audio clip attributes settings. Such attributes include length of playing time (audio clip duration), the particular or predetermined portion of the audio file to play (audio clip segment or portion), an audio file category, data in an ID3 tag (in the case of an MP3 audio data file) and/or the like.

In one form, there is provided a method of compiling a playlist for digital audio data files. The method includes the steps of: (a) selecting a set of digital audio data files in response to a first user input; (b) sequentially playing an audio clip from each one of the selected audio data files; and (c) including identifying data representative of the digital audio data file associated with a currently playing audio clip to the playlist of digital audio data files in response to a second user input.

The subject invention provides a method for creating playlists that greatly improves the speed of playlist creation and provides an overall better user experience than existing methods.

### BRIEF DESCRIPTION OF THE DRAWINGS

The above mentioned and other features and objects of this invention, and the manner of attaining them, will become more apparent and the invention itself will be better understood by reference to the following description of one embodiment of the invention taken in conjunction with the accompanying drawings, wherein:

FIG. 1 is a block schematic diagram of a portable audio data player in which the subject invention may be utilized;

FIG. 2 is a top view of the portable audio data player of FIG. 1;

FIG. 3 is a back view of the portable audio data player of FIG. 1;

FIG. 4 is a right side view of the portable audio data player of FIG. 1; and

FIG. 5 is a flowchart of an exemplary manner of operation of the present invention.

Corresponding reference characters indicate corresponding parts throughout the several views. Although the drawings represent embodiments of the invention, the drawings are not necessarily to scale and certain features may be exaggerated in order to better illustrate and explain the present invention. The exemplification set out herein illustrates one embodiment of the invention, in one form, and such exemplification is not to be construed as limiting the scope of the invention in any manner.

### DESCRIPTION OF THE INVENTION

The embodiment disclosed herein is not intended to be exhaustive or limit the invention to the precise form disclosed, but rather is described in a manner that others skilled in the art may utilize its teachings.

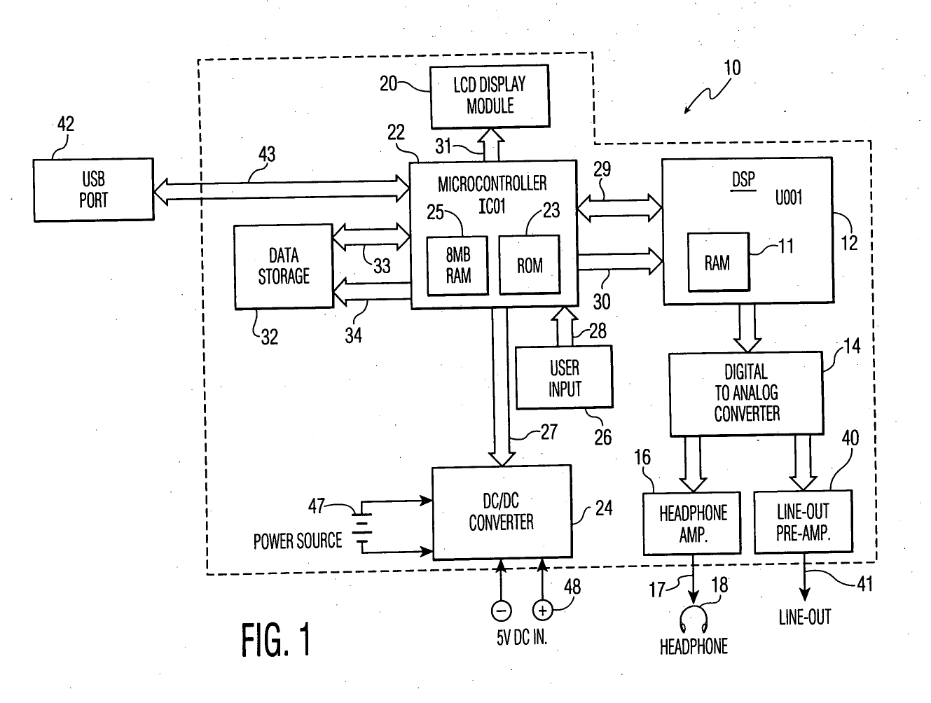

FIG. 1 shows a block diagram of portable audio data player 10 in which the subject invention may be utilized and/or embodied. It should be appreciated that the portable audio data player 10 is only exemplary of the type of device or component that may utilize and/or embody the principles of the subject invention. As such, the portable audio data player 10 is representative of those other devices and/or components utilizing and/or embodying the present invention, some but not necessarily all of which may be discussed herein. Such other devices include hard drive and flash memory audio data players, compact disc players, DVD players, and PVR products and/or the like.

The general arrangement and operation of the various elements of portable audio data player 10 are described herein both in general and in the context of the present invention. However, the details of the various elements of audio data player 10 are well known to those skilled in the art and will not be discussed in detail here. Audio data player 10 comprises microcontroller (controller) 22 that controls the various elements and the overall operation of audio data player 10, including transferring data from data storage 32, through buffer memory 25, and to audio decoder digital signal processor (DSP) 12. Microcontroller 22 includes a suitable amount of memory 23, for storing various instruction sets and programs for controlling the operation of audio data player 10 including carrying out or implementing the principles of the present invention. As pointed out in greater detail below, the method according to the principles of the subject invention may be utilized by other types of devices or components that play audio from a multitude of pre-recorded content, especially digital audio content, data and/or files.

DSP 12 may be programmed to perform a variety of signal processing functions during playback of a selected audio data file as well as selective segments or portions (i.e. audio clips) of audio data files. In this case, the functions that DSP 12 performs during playback include, but are not limited to, decoding audio data files, volume control, digital sound equalization, and sample conversion. The DSP 12 also performs other functions necessary to implement the principles of the subject invention as well other typical functions not necessarily discussed herein. In that regard, DSP 12 includes onboard memory 1 1, wherein the decoder files, audio data files, audio clips, equalizer mode selection, and various other required data are loaded during playback.

The decoder files comprise programs that control the decoding operations of DSP 12 the audio data files including audio clips include data associated with the audio content. Both the audio data files and the decoder files may be stored in data storage device 32. The decoder file including the programs is transferred to DSP memory 11 from data storage device 32. Alternatively, the decoder files may be stored in ROM 23, RAM 11 or other suitable storage device of player 10. Further, the decoder files and other system files and programs may also be stored in SDRAM 25, EEPROM 21 or other suitable storage devices coupled to DSP 12.

Audio data and decoder programs stored in data storage device 32 may be encrypted, requiring that decoding program files and audio data files be decrypted by DSP 12 using one or more decryption keys. The decryption keys may also be stored in data storage device 32 and may be security linked to the particular storage device or some other coded component of audio data player 10 so that audio data files encrypted for use on a particular audio data player may only be decrypted and played by that particular audio data player.

As a selected audio file is decoded, DSP 12 provides the decoded data stream to digital to analog converter 14. D/A converter 14 converts the digital output of DSP 12 into an analog signal and provides the analog signal to headphones amplifier 16 and lineout pre-amp 40. The analog signals are amplified and provided to lineout jack 41 and headphones hack 17, both disposed on housing 13 of audio player 10. It is to be understood that although the various elements are shown as separate elements, they may be combined and embodied in combination elements. For example, the microcontroller and the DSP may be implemented using a single integrated circuit.

Audio player 10 is adapted to operate with data storage device 32. In this embodiment, data storage device 32 is a moving data storage device, specifically a hard drive, that can be used to store various data files, including encoded audio data files, decoder files for controlling the decoding operation of DSP 12, playlist files, audio clips, and computer data files. A large amount of data can be readily transferred between data storage device 32 and microcontroller 22 through data bus 33. Data storage device 32 may also comprise any other suitable storage device and may be in removable form, for example a flash memory or a microdrive. Buffer memory 25 operates as a circular data buffer to prevent interruption of audio playback caused by a skip or other similar moving data storage device data transfer delays.

Moreover, buffer memory 25 receives and temporarily stores the audio clips taken from the selected audio data files. Buffer memory 25 then provides the audio clips to DSP 12 for sequential playback. Thus, buffer memory 25 continuously receives audio clip data for playback in the playlist creation mode of audio data player 10. In this regard, buffer management is desired in order to avoid response time problems during audio clip playback. By keeping a predetermined amount of seconds of the previous audio clip and the next audio clip in buffer memory 25, audio data player 10 may skip immediately to the next audio clip when desired. The predetermined amount of time needed preferably equates to the time necessary to load up the rest of the buffer memory. This may be on the order of ten (10) seconds. When audio data player 10 is in an audio clip mode (e.g. during playlist creation, building or population), the audio clips are loaded into buffer memory 25 for the current set of audio data files and also an audio clip from at least one and possible two other adjacent sets of audio data files in anticipation that the user may move in that direction.

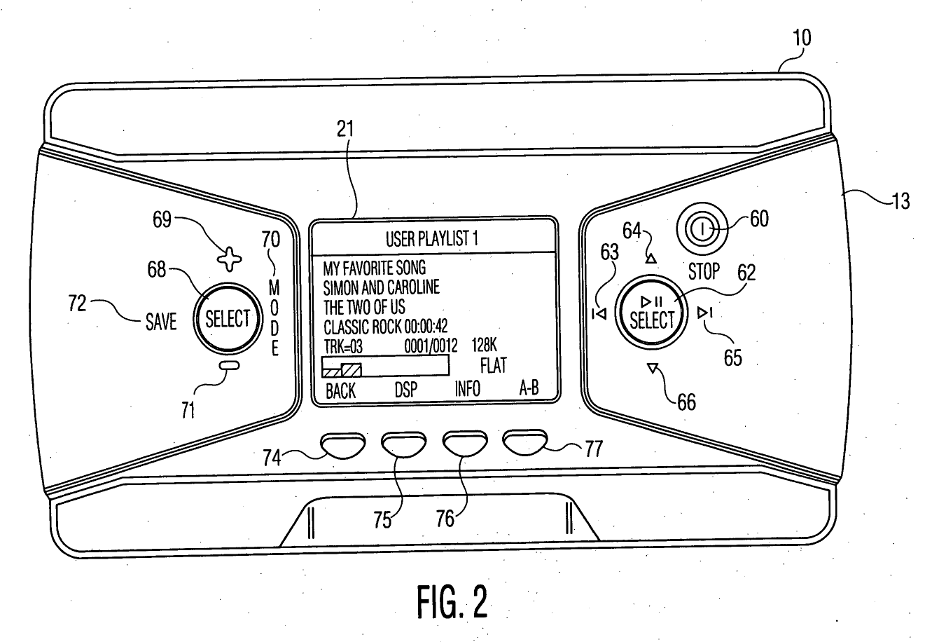

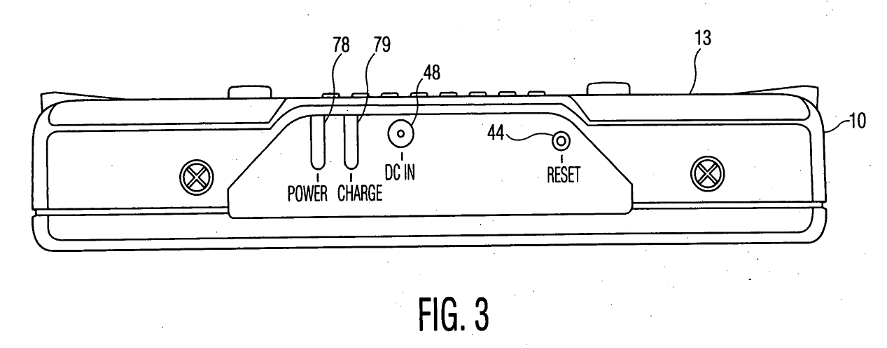

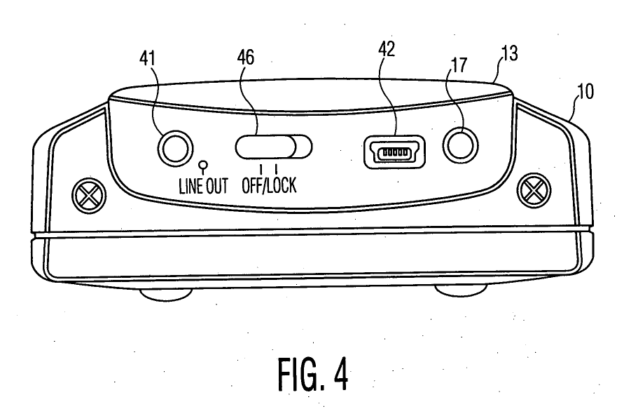

FIGS. 2-4 illustrate an exemplary embodiment of the displays, buttons, switches, indicators and ports that may be disposed on housing 13 of audio data player 10 that are used as indicated herein to carry out the principles of the present invention. Particularly, one or more of the various buttons constitute a user interface or user input device for allowing the user to make selections appropriate for the particular mode of digital audio player 10. Particularly, referring to FIG. 2, user input 26 comprises a plurality of buttons 44 (FIG. 3), 46 (FIG. 4) and 60-77 disposed on housing 13 of audio data player 10 for allowing a user to sort and select particular audio data files for playback, to control playback settings, select a set or collection of audio data files, select preferences for attributes for playback of audio clips, inclusion or adding of identifying data representative of an associated audio data file for a currently playing audio clip into a preferably, but not necessarily, selectable playlist, skipping the inclusion of identifying data representative of an associated audio data file for a currently playing audio clip, and/or other features and/or functions associated with a typical audio data player and the principles of the present invention.

User input 26 may also comprise other input devices known in the art, for example, keyboard, voice activated touch pad, and touch screen input devices. Two multi-way switches comprise buttons 62-66 and 68-72. Soft keys 74-77 are multi-function buttons whose function change for various user interface menu displays. Audio data player 10 also includes display 21 disposed on housing 13. Display 21 displays the audio data files, playlists and audio clip information stored in data storage 32, the function of soft keys 74-77, and various status information associated with audio data player 10, such as the playback status shown in FIG. 2 as well as top level menus.

In FIG. 2, STOP/POWER button 60 allows the user to stop playback and to turn audio data player 10 on and off. PLAY/PAUSE button 62 allows the user to start playback and to pause playback. Left arrow button 62 allows a user to move a highlight left when using the menu, and to skip back to the previous audio data file or audio clip, or scan backward in the present audio data file when playing music. The right arrow button 65 allows the user to move a highlight right when using the menu, skip forward to the next audio data file or audio clip, and scan forward in the current audio data file when playing music. Up arrow button 64 allows the user to move the highlight up when using the menu. Down arrow button 66 allows the user to move the highlight down when using the menu.

Referring still to FIG. 2, SELECT button 68 allows the user to select a highlighted item. Volume up button 69 increases the playback volume level for headphone 18 and volume down button 71 decreases the volume level. MODE button 70 allows the user to select a particular playback mode, including NORMAL, REPEAT, REPEAT ONE, REPEAT ALL, SHUFFLE, REPEAT ALL SHUFFLE, and playlist creation modes PLAYLIST CREATION, and AUDIO CLIP PREFERENCE SETTINGS. Soft keys 74-77 select the menu item that appears just above each button at the bottom of display 21.

Referring to FIG. 3, POWER indicator 78 lights when audio player 10 is on. CHARGE indicator 79 lights when the power source 47 is charging. CD IN jack 48 provides 5 volt DC from an AC adaptor to power audio data player 10. RESET button 44 allows the user to reset all of the audio data player settings to the factory defaults.

Referring now to FIG. 4, OFF/LOCK switch 46 allows the user to make buttons 60-77 inactive when switch 46 is slid to the locked position. LINEOUT jack 41 allows a user to connect the audio data player to a separate audio system. Headphones jack 17 allows the user to play the decoded audio on headphones 18. USB port 42 provides connection of audio data player 10 to a PC or other similar device using a USB cable.

In accordance with the principles of the subject invention, the above described audio data player 10 is further operative to allow a user to create a playlist or playlists of or for audio data files using audio identification or indicia. The present invention is particularly advantageous for use in a device having a relatively small display, or no display at all. It should be appreciated, however, that the present method is also applicable to PC use, implemented as audio file management software. The principles described herein with respect to the creation of a playlist is thus applicable to the software implementation in a PC as well as the other devices mentioned herein. Likewise, the principles of playlist creation as described herein (as software and/or hardware) is applicable to other devices and/or components that utilize audio data files.

Generally, in order to initiate the method of the present invention, the audio data player (or software with respect to a PC or other device/component), is caused to be in (put into) a playlist creation mode by selecting the mode in the main menu. From the playlist creation mode, a new playlist by default or a user selectable old or new playlist is chosen. A set of audio data files is selected by the user, for example, the songs by a particular artist, or in a particular genre or album. An audio clip (audio indicia or indication) from each one of the selected set of audio data files is then sequentially played. During playback of an audio clip, the user may add the selection to the playlist, for example, by pressing key 68 or a designated one of the keys 74-77 as specified. Particularly, identifying data representative of the audio file associated with the currently playing audio clip is added to the playlist in response to user input. The identifying data may be the well known data for generating a playlist, for example the pathnames associated with the selected songs. Each audio clip is then played until the last audio clip is reached. In this manner, a playlist is assembled. Editing of a playlist may take the same form by allowing a user to delete a song in a playlist after hearing an audio clip of the song. As well, it should be appreciated that the user may end the sequential playing at any time by for example, pressing the STOP key 60.

It will be assumed that a plurality of audio data files exist on audio data player 10. As such, the selection of particular audio data files to sample (hear audio clips from) may be made individually or via a set of audio data files. A set of audio data files may be assembled through use of identification data such as that contained in an ID3 tag of an MP3 encoded audio data file (or other similar manner) associated with the audio data file. The present invention is applicable with any encoding format (compressed audio data files) as well as uncompressed audio data files.

An example of the above will be described. The user may select a particular album. Audio clips from each of the songs from that album are assembled (buffered accordingly) and start to play in album order. While the audio clip is playing, a press of a designated key by the user will add it to the playlist. Once it has been added, the audio player advances to the next song (audio clip) and so on until the end of the album (set) is reached. If the audio clip length is set to five (5) seconds and there are twelve (12) songs on the album, a playlist can be created in less than 60 seconds.

As another example, the user selects one or all of artist, genre, or year. Audio clips are assembled and played from that group. While the audio clip is playing, user input adds the selection to the playlist. Once the playlist has been populated, the player advances to the next group. Likewise, the user may skip the selection at any time during playback, which does not add the selection to the playlist but advances playback to the next song.

In an alternative embodiment, the selected audio track can be placed in one of a plurality of playlists by using a second key in addition to the first key (e.g. favorites key) that identifies a particular playlist. For example, if there is a numeric keypad, a selection of a number within a predetermined period of time after pressing the Favorites Key places the selected audio track into a particular playlist. For example, pressing the sequence “Favorite Key” and then the number “1” results in the placement of the audio track in the first playlist. Other keys besides numeric keys may be used to identify the playlist as desired.

The user may also modify default settings regarding the attributes of the audio clips to be played. Particularly, the length of time (duration) that each audio clip plays may have a default setting that is user modifiable. The portion of the audio data file to which the audio clip will pertain (segment or offset of the audio data file) may have a default or predetermined setting (e.g. play the first, middle or last portion of the audio data file) which may be user modifiable. Alternatively, the portion of the audio file played may be selected to be dependent upon the type of audio clip being played (e.g. genre, album, artist, etc.) Alternatively, the portion of the audio data file played in the audio clip may be selected to be dependent on information (data or metadata) contained in an identification tag (e.g. an ID3 tag) associated with the audio data file or other information area of the particular encoding format. Other attributes may be modifiable as appropriate. Thus, the characteristics of the playing of the audio clip (of a portion of the audio data file) may be customized by the user as desired.

This invention may be implemented in a digital audio playback device having the standard audio signal processing elements and a control element such as those described above. Various implementation parameters may be modifiable such as audio prompts, audio clips and autoplay could be set up as user adjustable or selectable. Possible adjustment parameters include clip duration (in seconds), where to start and/or how far into a song to start playing an audio clip (i.e. where in the song to start the audio clip) and how many clips to allow in a play menu. The device may be arranged to continue to play the audio clip until the user indicates the decision to add or not to add the song associated with the clip to the playlist by pressing, for example one of the keys designated to indicate the song should be added, or a key designated to indicate the song should not be added. Upon pressing either key, the device begins to play the next audio clip.

With respect to implementation of the present invention in PC audio data file management software, exemplary manners of at least partial implementation are presented. In one example, a list of songs is shown on the display. This could represent any collection of music such as a list, of songs representing an album sort, songs by a particular artist, a playlist or various other sorts or even random lists of songs. By moving the cursor over a selection, the system could be setup to optionally play an audio clip from the highlighted item. While the audio clip is playing, a mouse button click would add the song to a working playlist. In another example, but with the same list as the first example, a left click on any item in the list will highlight the item. An automatic progression would then start an audio clip of a given amount of time, which would then play from a given offset into the song. While the clip is playing, a right click of the mouse would add the item to a working playlist. Once added, the curse would move on to the next item, or if not added, then it would move on to the next item at the end of the clip duration.

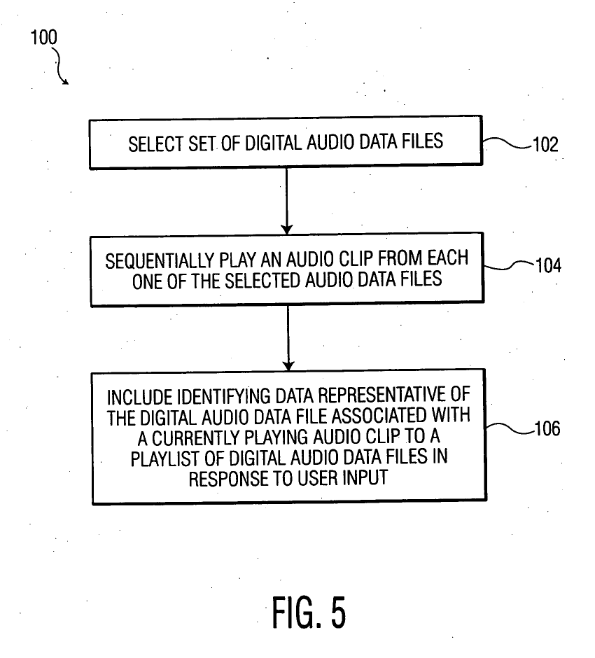

Referring to FIG. 5, there is depicted a flowchart, generally designated 100, of a general manner of creating a playlist in accordance with the principles of the subject invention. Particularly, the flowchart 100 depicts a general manner in which a playlist may be created, built, compiled, and/or edited in accordance with the principles of the subject invention.

In block or step 102, a set of digital audio data files is selected. This is typically accomplished by the user. Particularly, in response to user input, a set of digital audio data files is selected. In block or step 104, an audio clip from each one of the selected audio data files is sequentially played. In block or step 106, the user adds the audio clip to the playlist (wherein identifying data representative of the digital audio data file associated with a currently playing audio clip is included into a playlist) through the user interface.

Of course, as indicated above, attributes of the audio clips to be played may be selected by the user prior to the selection of the set of audio data files. Such attributes include, but are not limited to, the length of audio clip play time, the portion of the audio clip to be played, and/or the like.

It should be appreciated that the flowchart 100 described above and depicted in FIG. 5 provides a complete manner of exemplary operation of the subject satellite receiving system as described herein. The subject invention may be implemented utilizing less or different steps than all of the steps of the flowchart 100. This may be reflected in the claims. Moreover, more or less steps in alternative embodiments of the procedure, method or operation 100 may implement the subject invention in accordance with the principles recited herein. As well, subsets of the above procedure 100 may implement the principles of the subject invention rather than the entire procedure. Variations are also contemplated.

While this invention has been described as having a preferred design, the present invention can be further modified within the spirit and scope of this disclosure. This application is therefore intended to cover any variations, uses, of adaptations of the invention using its general principles. For example, although various keys are shown for allowing user selection in the embodiment, it is clear that user selection of the songs may be performed using other methods of user interface, for example, using a mouse, a touch screen, joystick, softkeys, etc. Further, this application is intended to cover such departures from the present disclosure as come within known or customary practice in the art to which this invention pertains and that fall within the limits of the appended claims.

What is claimed is:

1. A method of compiling a playlist of digital audio data files comprising the steps of:
selecting a set of digital audio data files in response to a first user input;
sequentially playing an audio clip from each one of the selected audio data files; and
including identifying data representative of the digital audio data file associated with a currently playing audio clip to the playlist of digital audio data files in response to a second user input.

2. The method of claim 1, wherein each audio clip is taken from a predetermined portion of its associated audio data file that is selectable by the user.

3. The method of claim 1, wherein each audio clip is taken from a portion of its associated audio data file according to an audio clip parameter of an associated data tag of the audio data file.

4. The method of claim 1, wherein each audio clip is taken from a portion of its associated audio data file depending on a genre characteristic of the audio data file.

5. The method of claim 1, wherein each audio clip is played for a predetermined duration selectable by the user.

6. The method of claim 1, wherein each audio clip continues to be played until the user selects to add or not add the associated audio data file corresponding to the currently playing audio clip to the playlist.

7. The method of claim 1, further comprising the step of allowing user selection of one of a plurality of playlists to which to include the identifying data.

8. A digital audio data player comprising:
a data storage device for storing a plurality of digitally encoded audio data files;
a signal processing unit for receiving a selected collection of the stored digitally encoded audio data files, decoding an audio clip of each one of the stored digitally encoded audio data files of the selected collection, and playing the decoded audio clip of each one of the stored digitally encoded audio data files;
a user input device for accepting user input; and
a controller, coupled to the data storage device, the signal processing unit, and the user input device, for controlling the operation of the data storage device and the signal processing unit in response to user input,
wherein the controller allows inclusion of identifying data representative of the stored digitally encoded audio data file associated with a currently playing audio clip to a playlist of digitally encoded audio data files.

9. The digital audio data player of claim 8, wherein the controller allows inclusion of identifying data to a user selectable playlist of digitally encoded audio data files of a plurality of playlists of digitally encoded audio data files.

10. The digital audio data player of claim 8, wherein the controller is operative to take each audio clip from a predetermined portion of its associated audio data file that is selectable by the user.

11. The digital audio data player of claim 8, wherein the controller is operative to take each audio clip from a portion of its associated audio data file according to an audio clip parameter of an associated data tag of the audio data file.

12. The digital audio data player of claim 8, wherein the controller is operative to take each audio clip from a portion of its associated audio data file depending on a genre characteristic of the audio data file.

13. The digital audio data player of claim 8, wherein the controller is operative to play each audio clip for a predetermined duration.

14. The digital audio data player of claim 8, wherein the controller is operative to continue to play each audio clip until the user selects to add or not add the associated audio data file corresponding to the currently playing audio clip to the playlist.

15. In a digital audio data player, a method of compiling a playlist of digital audio data files comprising the steps of:
allowing user selection of a plurality of audio data files;
sequentially playing an audio clip from each one of the selected plurality of audio data files; and
during playing of an audio clip, populating a playlist with identifying data representative of the stored audio data file associated with the currently playing audio clip in response to user input.

16. The method of claim 15, further comprising the step of allowing user selection of one of a plurality of playlists to which to include the identifying data.

17. The method of claim 15, wherein each audio clip is taken from a predetermined portion of its associated audio data file selectable by the user.

18. The method of claim 15, wherein each audio clip is taken from a portion of its associated audio data file according to an audio clip parameter of an associated data tag of the audio data file.

19. The method of claim 15, wherein each audio clip is taken from a portion of its associated audio data file depending on a genre characteristic of the audio data file.

20. The method of claim 15, wherein each audio clip is played for a predetermined duration selectable by the user.

21. The method of claim 15, wherein each audio clip continues to be played until the user selects to add or not add the associated audio data file corresponding to the currently playing audio clip to the playlist.
